(19) United States
(12) Patent Application Publication
(10) Pub. No.: US 2005/0231753 A1
(43) Pub. Date: Oct. 20, 2005

(54) Method, apparatus and computer program product for printing document data

(76) Inventors: Markus Mertama, Tampere (FI); Esa Etelapera, Tampere (FI)

Correspondence Address: CRAWFORD MAUNU PLLC, 1270 NORTHLAND DRIVE, SUITE 390, ST. PAUL, MN, 55120, US

(21) Appl. No.: 10/828,447

(22) Filed: Apr. 20, 2004

(51) Int. Cl. G06K 15/00

(52) U.S. Cl. 358/1.15; 382/232; 715/513

(57) ABSTRACT

A data processing device, a method for printing document data from a data processing device to a printer, and a computer program product encoding a computer program of instructions for executing a computer process for printing document data from a data processing device to a printer are disclosed. In the method at least one compressed image file is defined in a definition file written in a markup language, and document data is printed into the compressed image file. The definition file and the compressed image file are transferred to a printer capable of interpreting the definition file and printing the compressed image file, whereby the document data is printed.

### FIELD

The invention relates to a data processing device, a method for printing document data from a data processing device to a printer, and a computer program product encoding a computer program of instructions for executing a computer process for printing document data from a data processing device to a printer.

### BACKGROUND

Printing document data from a data processing device over a connection to a printer may be problematic. This is because generally all printers require that the data processing device print with a specific printer driver designed just for that printer. Especially for manufacturers of mobile data processing devices it is almost impossible to provide and store all the possible printer drivers.

If the data processing device prints over a Bluetooth® connection to the printer then a protocol called Basic Printing Profile (BPP) may be used. BPP provides a standard solution using XHTML™-Print, which is a XHTML (Extensible Hypertext Markup Language) based data stream suitable for printing. But BPP has certain restrictions: it does not support what-you-see-is-what-you-get or WYSIWYG printing (in a pixel-perfect fashion), and certain features such as common drawing primitives are totally missing.

### BRIEF DESCRIPTION OF THE INVENTION

The present invention seeks to provide an improved data processing device, an improved method for printing document data from a data processing device to a printer, and an improved computer program product encoding a computer program of instructions for executing a computer process for printing document data from a data processing device to a printer.

According to an aspect of the present invention, there is provided a data processing device, comprising a transceiver; and a processing unit coupled to the transceiver configured to define at least one compressed image file in a definition file written in a markup language, to print document data into the compressed image file, and to transfer the definition file and the compressed image file with the transceiver to a printer capable of interpreting the definition file and printing the compressed image file, whereby the document data is printed.

According to another aspect of the present invention, there is provided a method for printing document data from a data processing device to a printer, comprising: defining at least one compressed image file in a definition file written in a markup language; printing document data into the compressed image file; and transferring the definition file and the compressed image file to a printer capable of interpreting the definition file and printing the compressed image file, whereby the document data is printed.

According to another aspect of the present invention, there is provided a computer program product encoding a computer program of instructions for executing a computer process for printing document data from a data processing device to a printer, the process comprising: defining at least one compressed image file in a definition file written in a markup language; printing document data into the compressed image file; and transferring the definition file and the compressed image file to a printer capable of interpreting the definition file and printing the compressed image file, whereby the document data is printed.

According to another aspect of the present invention, there is provided a data processing device, comprising means for communicating with a printer; means for defining at least one compressed image file in a definition file written in a markup language; means for printing document data into the compressed image file; and means for transferring the definition file and the compressed image file with the means for communicating to a printer capable of interpreting the definition file and printing the compressed image file, whereby the document data is printed.

The present invention provides several advantages. With the invention, it is possible to print document data of high quality, even in a WYSIWYG fashion, without having to implement a massive amount of different printer drivers to a certain data processing device.

### LIST OF DRAWINGS

In the following, the invention will be described in greater detail with reference to the embodiments and the accompanying drawings, in which

FIG. 1 is a block diagram illustrating an embodiment of the data processing device;

FIGS. 2 and 3 illustrate how a document data page may be split into image files;

FIG. 4 is a flow diagram illustrating an embodiment of the document data printing method; and

FIG. 5 is a signal sequence chart illustrating an embodiment of the document data printing method.

### DESCRIPTION OF EMBODIMENTS

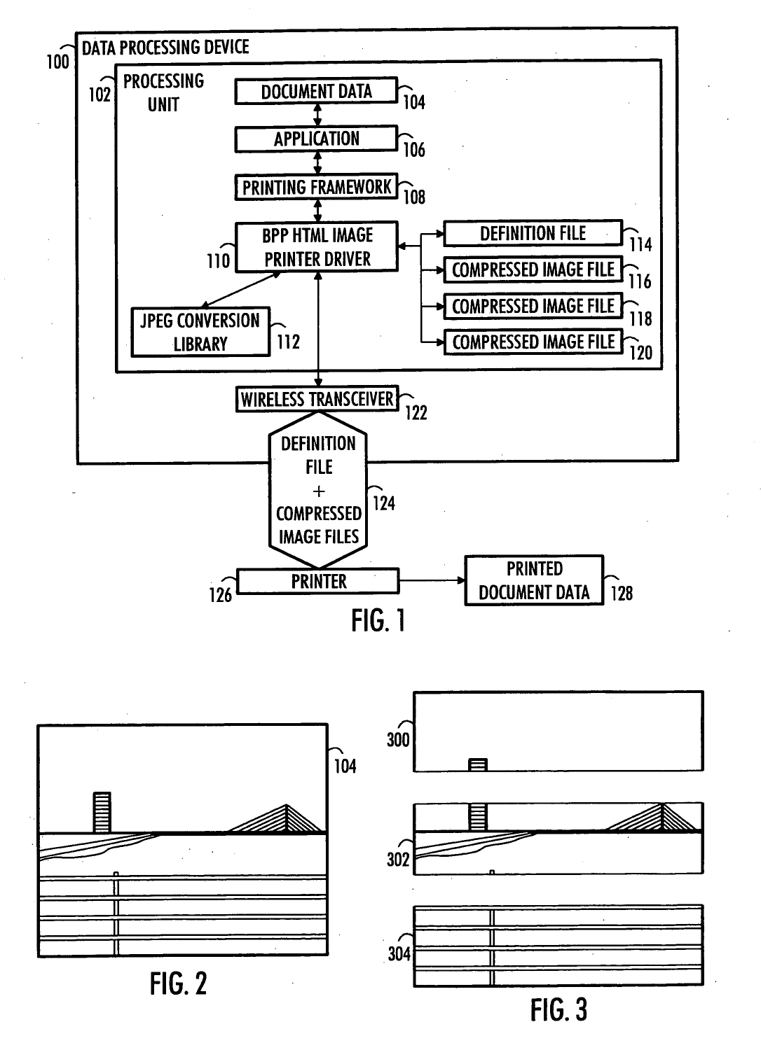

With reference to FIG. 1, examine an embodiment of a data processing device 100, whereto the embodiments of the invention can be applied. The term ‘data processing device’ refers to modern information processing devices such as computers, mobile phones, PDAs (Personal Digital Assistant) and the like. Such data processing devices 100 may be fixedly positioned or portable. Data processing devices 100 may also combine the roles of different kinds of devices. One example of such devices is Nokia® Communicator™; a combination of a mobile phone and a PDA. Another example is Nokia® N-Gage™, a combination of a mobile phone, a game deck, an MP3 player, and a wireless browser.

The data processing device 100 communicates over a connection 124 with a printer 126. In order to do this, the data processing device 100 includes a transceiver 122. The transceiver 122 may be a wireless transceiver as illustrated in FIG. 1. The wireless transceiver 124 may utilize radio communication techniques. One example of radio communication techniques is Bluetooth® technology, but other wireless radio communication techniques, such as other short-range wireless communication techniques, may also be applied. Besides radio communication techniques, also other wireless communication techniques based on the use of electric and/or magnetic waves may be used. Besides wireless communication techniques, also known suitable wired communication techniques may be used. One suitable wired communication technology is based on the use of USB (Universal Serial Bus).

The data processing device 100 also includes a processing unit 102 coupled to the transceiver 122. The processing unit 102 may be implemented in ways known in the art of computers and subscriber terminals. Implementation techniques include: one or more processors, depending on the necessary processing power, one or more application-specific integrated circuits (ASIC), one or more integrated circuits (IC), one or more electronic circuits. In the processor, software that implements part of the desired functionality may be run. A combination of these different implementation techniques may also be used: the data processing device 100 may include one or more ASICs for processing the communication signals and further, one or more microprocessors for processing other data. Specialized processors, for example for processing game data, may also be utilized. It is to be noted that this list of various implementation possibilities may not be exhaustive, but also other implementation techniques may be used.

Because the current embodiments relate to printing, other structural parts of the data processing device 100 are not further described here. Such parts may include, among other things: memory devices, user interface elements (keyboards, displays, buttons, pointing devices, loudspeakers, microphones) and transceivers of a cellular radio network, such as GSM (Global System for Mobile Communications, UMTS (Universal Mobile Telecommunications System), or GPRS (General Packet Radio Service).

The processing unit 102 includes an application 106 that processes document data 104. The application 106 may be a software application such as Microsoft® Word™, Microsoft® Excel™, Microsoft® PowerPoint®, Microsoft® Outlook®, or Microsoft® Internet Explorer™. Naturally, the application 106 may also be any other application used for processing document data 104. The document data 104 may include any alphanumeric or image data, which can be printed (on paper, foil, photography paper, or any other known material used for prints). One typical example of document data 104 includes a PowerPoint™ presentation. Such a presentation includes one or more slides, and each slide may include a number of alphanumeric text fields placed on the slide and a number of images placed on the slide.

The processing unit 102 is configured to define at least one compressed image file in a definition file written in a markup language and to print document data into the compressed image file. Let us study a simple example how this can be achieved. FIG. 2 illustrates one page of document data 104 that could be one slide of PowerPoint™ presentation, for example. The document data 104 shows a photograph taken aboard a ship over its banisters towards a high-rise building and a bridge in the horizon.

In FIG. 3 we see how the document data 104 is split into three images 300, 302, 304. This may be achieved with a printing framework 108 with which the application 106 interacts in order to get the document data 104 printed. The printing framework 108 may include an operating system, such as Symbian®. The printing framework 108 may split the document data 104 into three images 300, 302, 304 by printing the document data 104 into three files with a BPP HTML image printer driver 110. Next, these three files may be compressed with some compression application 112 into three compressed image files 116, 118, 120. The compression application 112 may utilize any known compression algorithm. In our example, JPEG (Joint Photographic Experts Group) may be used as the compression algorithm.

The BPP HTML image printer driver 110 also takes care of the generation of the definition file 114 written in a markup language. The markup language is used to describe the structure of structured data, based on the use of specified tags. Markup languages include, but are not limited to, XML (Extensible Markup Language), HTML (Hypertext Markup Language), and XHTML (Extensible Hypertext Markup Language). More information on the use of the XHTML in connection with printing may be obtained from the document “XHTML™-Print”, Draft 0.95, Jan. 1, 2002, or other documents relating to it published by the World Wide Web Consortium (W3C), whose current web-address is www.w3.org. In the following, an example definition file 114 is shown:

```
<?xml version=“1.0” encoding=“UTF-8”?>
<!DOCTYPE html
  PUBLIC “-//W3C//Dtd Xhtml 1.0 Transitional//EN”
  “http://www.w3.org/TR/xhtml1/DTD/xhtml1-strict.dtd”>
<html xmlns=“http://www.w3.org/1999/xhtml” xml:lang=“en” lang=“en”>
<head>
<title>
Example image
</title>
<style type=“text/css” id=“internalStyle”>
td img {display: block;}
</style>
</head>
<body>
<table cellspacing=“0” cellpadding=“0”>
<tr>
<td>
<img src=“test_1.jpg” alt=“part1” width=“352” height=“96”/>
<img src=“test_2.jpg” alt=“part2” width=“352” height=“96”/>
<img src=“test_3.jpg” alt=“part3” width=“352” height=“80”/>
</td>
</tr>
</table>
</body>
</html>
```

In the embodiment, illustrated by the above-shown definition file 114, the processing unit 102 is configured to include in the definition file 114 a reference to the compressed image file. If we map this definition file 114 to the example of FIGS. 2 and 3, we could say that the document data 104 is now split into three compressed image files, test_{—}1.jpg, test_{—}2.jpg and test_{—}3.jpg, each containing one split image 300/302/304.

In another embodiment, the processing unit 102 is configured to include in the definition file 114 information on the decomposition of the document data 104 into the compressed image files 116, 118, 120. One way to ensure that the compressed image files 116, 118, 120 are in a correct position is to put them in a table and to use a Cascading Style Sheet (CSS) definition, as shown above.

In an embodiment, the processing unit 102 is configured to paginate the document data 104. The size of the print material may be received from the printer 126 via the transceiver 122 or it may be a default value known by the printing framework 108. DIN (Deutsche Industrie-Norm) standard may be used for defining the size of the print material, for example. Examples of DIN standard sizes include DIN A3, A4 and A5. Also the size of the printable area needs to be known. The processing unit 102 may be configured to split each page of the paginated document data 104 into bands having a predetermined width and height. The bands may be as described in FIG. 3. The processing unit 102 may be configured to print each band into the compressed image file 116/118/120. Due to memory restrictions of the data processing device 100 and/or the printer 126, the printing may have to be done in relatively small bands. One DIN A4 page with normal 600 dpi (dots per inch) resolution requires 25 megabytes of memory. When printing in bands, a page is split in parts, and the definition file 114 is used to print the parts as one page. When printing starts it is calculated how many bands are needed for document data and what are their sizes. This may be calculated as page size and printable area sizes are known.

In an embodiment, the processing unit 102 is configured to print the document data 104 into the compressed image file 116, 118, 120 in a what-you-see-is-what-you-get or WYSIWYG fashion. A WYSIWYG result may be achieved so that the processing unit 102 is configured to print the document data 104 into the compressed image file 116, 118, 120 in two stages including the printing of the document data into a bit map file and converting the bit map file into the compressed image file.

The processing unit 102 is configured to transfer the definition file 114 and the compressed image file 116, 118, 120 with the transceiver 122 to a printer 126 capable of interpreting the definition file 114 and printing the compressed image file 116, 118, 120, whereby the document data 104 is printed. As illustrated in FIG. 1, the definition file and the compressed image files are transferred 124 from the data processing device 100 to the printer 126, and the printer 126 outputs the printed document data 128. The internal parts of the printer 126 are not further described here, but it is clear that the printer 126 includes a transceiver supporting the used communication protocol. An XHTML printer is described in U.S. 2002/0171857 that is incorporated herein as reference. In an embodiment, an Extensible Hypertext Markup Language XHTML™-Print file 114 includes the document data 104 as a composition of at least one JPEG (Joint Photographic Experts Group) file 116, 118, 120, and the XHTML-Print file 114 and the JPEG files 116, 118, 120 are transferred via the Bluetooth® transceiver 122 to a printer 126 utilizing the Basic Printing Profile BPP supporting XHTML and JPEG for printing. If JPEG is used as the compression algorithm, it may be required that the size of the printed document data is divisible by eight pixels.

Next, some embodiments enhancing the memory handling of the above-described data processing device 100 are described. These embodiments may also have an effect on the memory handling of the printer 126.

In a first embodiment, the processing unit 102 is further configured to delete the definition file 114 after it has been transferred to the printer 126.

In a second embodiment, the processing unit 102 is further configured to delete each compressed image file 116, 118, 120 after it has been transferred to the printer 120.

In a third embodiment, the processing unit 102 is further configured to divide the document data 104 into compressed image files 116, 118, 120 not exceeding a predetermined size limit.

In a fourth embodiment, the processing unit 102 is further configured to generate the compressed image file 118 after the previous compressed image file 116 has been transferred to the printer 126 and deleted from the processing unit 102.

In a fifth embodiment, the processing unit 102 is further configured to receive an image request from the printer 126 via the transceiver 122 and to transfer the compressed image file 116 via the transceiver 122 to the printer 126 in response to the received image request. In connection with the fifth embodiment, there may exist a sixth embodiment, in which the processing unit 102 is further configured to generate the compressed image file 116 after the image request for it has been received. These two embodiments may be implemented so that first a definition file 114, written in XHTML, is created and then sent to the printer 126. When the BPP printer 126 reads the definition file 114 and encounters an image link to a compressed image file 116, it uses a BPP object channel to retrieve the image 116 from the data processing device 100. The printer driver 110 in the data processing device 100 knows which band is requested to be rendered and creates a compressed image file 116 for that. After the compressed image file 116 is transferred to the printer 126 it can be deleted from the memory of the data processing device 100, thus only one band is in the memory of the data processing device 100 at any given time and minimum amount of memory is needed.

With these six embodiments it is possible to control the contents of the memory of the processing unit 102 in order to be able to print even large amounts of document data 104 without high memory capacity. It is to be noted that the document data 104 may fit into one compressed image file 116 or more than one compressed image files 116, 118, 120 may be needed. The number of compressed image files may depend on the above-mentioned pre-determined size limit for the compressed image file.

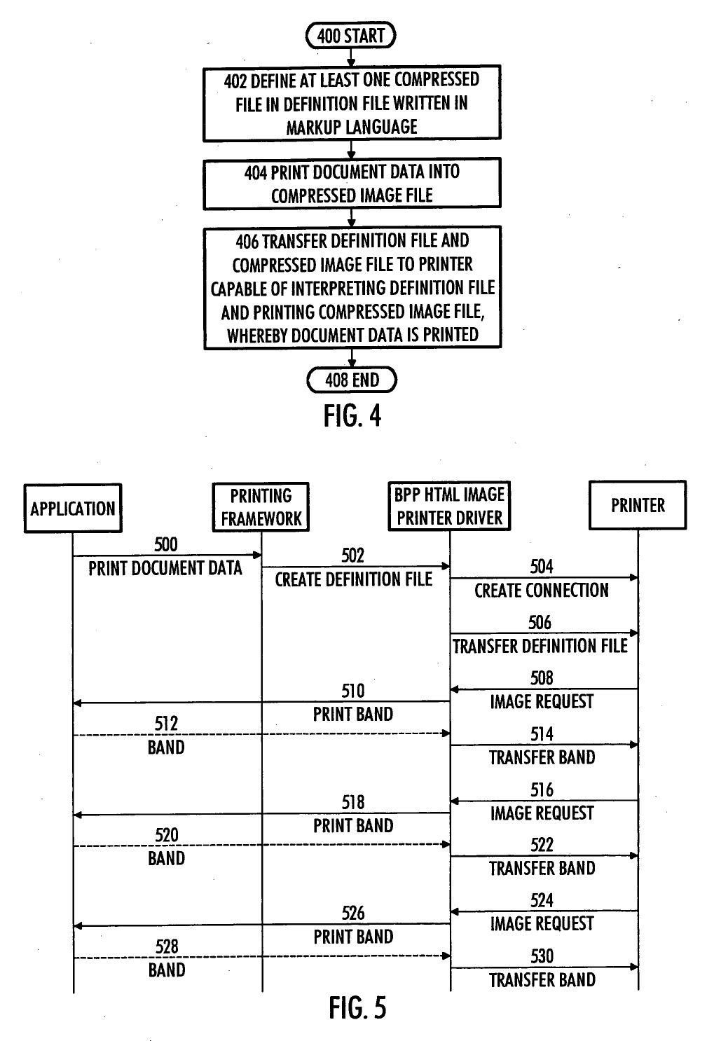

Next, with reference to FIGS. 4 and 5, a method for printing document data from a data processing device to a printer is described.

The method starts in 400. The method may be initiated by an application giving 500 a print document data command to a printing framework.

At least one compressed image file is defined in a definition file written in a markup language in 402. The printing framework may give 502 a create-definition-file command to a BPP HTML image printer driver.

Next, document data is printed into the compressed image file in 404. As explained above, this may be done so that all compressed image files are created in one go or one by one (possibly on-demand).

As explained above in connection with the data processing device 100, the definition file may include a reference to the compressed image file. It is possible to include in the definition file also information on the decomposition of the document data into the compressed image files.

Finally, in 406, the definition file and the compressed image file(s) are transferred to a printer capable of interpreting the definition file and printing the compressed image file(s), whereby the document data is printed.

After the printing method ends in the data processing device, the method ends in 408.

The data processing device 100 of the type described above may be used to implement the method, but also other types of data processing devices may be suitable for the implementation. In an embodiment, a computer program product encodes a computer program of instructions for executing a computer process of the above-described method for printing document data from a data processing device to a printer. The computer program product may be embodied on a computer program distribution medium. The computer program distribution medium includes all manners known in the art for distributing software, such as a computer readable medium, a program storage medium, a record medium, a computer readable memory, a computer readable software distribution package, a computer readable signal, a computer readable telecommunication signal, and a computer readable compressed software package.

FIG. 5 further illustrates some embodiments of the method. The BPP HTML image printer driver may create 504 a connection to the printer in order to transfer 506 the definition file. This may be done as described in the Bluetooth® specification “Basic Printing Profile Interoperability Specification”, Revision 0.95a, 2001-10-05. The data processing device acts as the sender. Naturally, the printer acts as the printer. Direct printing service may be used. OBEX (Object Exchange) protocol may be used to implement the communication between the sender and the printer. In the OBEX protocol the sender is the client and the printer is the server. The definition file may be transferred in a job channel with a FilePush operation from the client to the server.

In an embodiment the method further comprises: paginating the document data, splitting each page of the paginated document data into bands having a predetermined width and height, and printing each band into the compressed image file. The printing of the document data into the compressed image file may be done in a what-you-see-is-what-you-get or WYSIWYG fashion. In order to achieve WYSIWYG printing, the method may print the document data into the compressed image file in two stages including the printing of the document data into a bit map file and converting the bit map file into the compressed image file.

The server may fetch the compressed image files from the client using an object channel and a GetReferencedObjects operation. XHTML-Print format requires that the printer be able to retrieve objects (such as images) from the sender. In FIG. 5, we see three image requests 508, 516, 524 from the printer to the BPP HTML image printer driver. The BPP HTML image printer driver issues print band commands 510, 518, 526 to the application, and the application returns the printed bands 512, 520, 528. The bands are transferred 514, 522, 530 from the BPP HTML image printer driver to the printer. All in all, an image request may be received from the printer and the compressed image file may be transferred to the printer in response to the received image request.

In order to enhance the memory handling some optional operations may be done. The definition file may be deleted after it has been transferred to the printer. Each compressed image file may also be deleted after it has been transferred to the printer. The document data may be divided into compressed image files not exceeding a predetermined size limit. The compressed image file may be generated after the previous compressed image file has been transferred to the printer and deleted from the processing unit. The compressed image file may be generated after the image request for it has been received.

Even though the invention is described above with reference to an example according to the accompanying drawings, it is clear that the invention is not restricted thereto but it can be modified in several ways within the scope of the appended claims.

1. A data processing device, comprising
a transceiver; and
a processing unit coupled to the transceiver configured to define at least one compressed image file in a definition file written in a markup language, to print document data into the compressed image file, and to transfer the definition file and the compressed image file with the transceiver to a printer capable of interpreting the definition file and printing the compressed image file, whereby the document data is printed.

2. The data processing device of claim 1, wherein the processing unit is further configured to include in the definition file a reference to the compressed image file.

3. The data processing device of claim 1, wherein the processing unit is further configured to include in the definition file information on the decomposition of the document data into the compressed image files.

4. The data processing device of claim 1, wherein the processing unit is further configured to paginate the document data, to split each page of the paginated document data into bands having a predetermined width and height, and to print each band into the compressed image file.

5. The data processing device of claim 1, wherein the processing unit is further configured to print the document data into the compressed image file in a what-you-see-is-what-you-get or WYSIWYG fashion.

6. The data processing device of claim 5, wherein the processing unit is further configured to print the document data into the compressed image file in two stages including the printing of the document data into a bit map file and converting the bit map file into the compressed image file.

7. The data processing device of claim 1, wherein the processing unit is further configured to delete the definition file after it has been transferred to the printer.

8. The data processing device of claim 1, wherein the processing unit is further configured to delete each compressed image file after it has been transferred to the printer.

9. The data processing device of claim 1, wherein the processing unit is further configured to divide the document data into compressed image files not exceeding a predetermined size limit.

10. The data processing device of claim 1, wherein the processing unit is further configured to generate the compressed image file after the previous compressed image file has been transferred to the printer and deleted from the processing unit.

11. The data processing device of claim 1, wherein the processing unit is further configured to receive an image request from the printer via the transceiver and to transfer the compressed image file via the transceiver to the printer in response to the received image request.

12. The data processing device of claim 11, wherein the processing unit is further configured to generate the compressed image file after the image request for it has been received.

13. A method for printing document data from a data processing device to a printer, comprising:
defining at least one compressed image file in a definition file written in a markup language;
printing document data into the compressed image file; and
transferring the definition file and the compressed image file to a printer capable of interpreting the definition file and printing the compressed image file, whereby the document data is printed.

14. The method of claim 13, wherein the method further comprises:
including in the definition file a reference to the compressed image file.

15. The method of claim 13, wherein the method further comprises:
including in the definition file information on the decomposition of the document data into the compressed image files.

16. The method of claim 13, wherein the method further comprises:
paginating the document data;
splitting each page of the paginated document data into bands having a predetermined width and height; and
printing each band into the compressed image file.

17. The method of claim 13, wherein the method further comprises:
printing the document data into the compressed image file in a what-you-see-is-what-you-get or WYSIWYG fashion.

18. The method of claim 13, wherein the method further comprises:
printing the document data into the compressed image file in two stages including the printing of the document data into a bit map file and converting the bit map file into the compressed image file.

19. The method of claim 13, wherein the method further comprises:
deleting the definition file after it has been transferred to the printer.

20. The method of claim 13, wherein the method further comprises:
deleting each compressed image file after it has been transferred to the printer.

21. The method of claim 13, wherein the method further comprises:
dividing the document data into compressed image files not exceeding a predetermined size limit.

22. The method of claim 13, wherein the method further comprises:
generating the compressed image file after the previous compressed image file has been transferred to the printer and deleted from the processing unit.

23. The method of claim 13, wherein the method further comprises:
receiving an image request from the printer; and
transferring the compressed image file to the printer in response to the received image request.

24. The method of claim 23, wherein the method further comprises:
generating the compressed image file after the image request for it has been received.

25. A computer program product encoding a computer program of instructions for executing a computer process for printing document data from a data processing device to a printer, the process comprising:
defining at least one compressed image file in a definition file written in a markup language;
printing document data into the compressed image file; and
transferring the definition file and the compressed image file to a printer capable of interpreting the definition file and printing the compressed image file, whereby the document data is printed.

26. A data processing device, comprising
means for communicating with a printer;
means for defining at least one compressed image file in a definition file written in a markup language;
means for printing document data into the compressed image file; and
means for transferring the definition file and the compressed image file with the means for communicating to a printer capable of interpreting the definition file and printing the compressed image file, whereby the document data is printed.
